(19) United States
(12) Patent Application Publication
(10) Pub. No.: US 2025/0332985 A1
(43) Pub. Date: Oct. 30, 2025

(54) METHODS AND APPARATUS TO DETERMINE A LOAD PITCH ANGLE FOR HEADLAMP ADJUSTMENT

(71) Applicant: Ford Global Technologies, LLC, Dearborn, MI (US)

(72) Inventor: Matthias Reiter, Aachen (DE)

(21) Appl. No.: 19/190,016

(22) Filed: Apr. 25, 2025

(30) Foreign Application Priority Data
Apr. 29, 2024 (DE) 102024111961.6

(51) Int. Cl. B60Q 1/115; G01S 15/04; G01V 7/02

(52) U.S. Cl. CPC B60Q 1/115; G01S 15/04; G01V 7/02; B60Q 2200/30

(57) ABSTRACT

Methods and apparatus to determine a load pitch angle for headlamp adjustment are disclosed. A disclosed example method for determining a load pitch angle of a vehicle includes determining a first averaged pitch angle corresponding to a first set of pitch angles determined for a first time interval, determining whether a change in a load of the vehicle has occurred during the first time interval based on at least one parameter indicating a change in the load of the vehicle, determining, in response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred, calculating the load pitch angle based on the second averaged pitch angle, and adjusting a position of a headlamp of the vehicle based on the load pitch angle.

### RELATED APPLICATION

This patent claims priority from DE Patent Application Number 10 2024 111 961.6, which was filed on Apr. 29, 2024, and is hereby incorporated herein by reference in its entirety.

### FIELD OF THE DISCLOSURE

The disclosure relates to a method for determining the current load pitch angle of a vehicle for automatic headlamp beam height adjustment of at least one headlamp of the vehicle. The disclosure also relates to methods and apparatus for adjusting the beam of at least one headlamp.

### BACKGROUND

The term “pitch angle” refers to an instantaneous angle of a vehicle above the ground. The pitch angle can vary rapidly and can be influenced by the loading of the vehicle and the vehicle longitudinal dynamics, in particular braking, acceleration, as well as uphill and downhill due to additional power demand, as well as an unevenness of a road. As used herein, a factory state, a calibration state or a state of an unladen vehicle is defined as a state with a pitch angle of zero degrees. All other angles describe a deviation from the factory state or from the unladen state

### SUMMARY

An example method for determining a load pitch angle of a vehicle includes determining a first averaged pitch angle corresponding to a first set of pitch angles determined for a first time interval, determining whether a change in a load of the vehicle has occurred during the first time interval based on at least one parameter indicating a change in the load of the vehicle, determining, in response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred, calculating the load pitch angle based on the second averaged pitch angle, and adjusting a position of a headlamp of the vehicle based on the load pitch angle.

An example device for automatic beam height adjustment of at least one headlamp of a vehicle includes a first sensor to collect first data including a plurality of pitch angles, a second sensor to collect second data including at least one parameter indicating a change in a load of the vehicle, machine readable instructions, and programmable circuitry to execute the machine-readable instructions to determine a first averaged pitch angle corresponding to a first set of pitch angles determined for a first time interval based on the first data, determine whether a change in the load of the vehicle has occurred based on the second data, determine, in response to the change of the load of the vehicle occurring during the first time interval, a second averaged pitch angle corresponding to a second set of pitch angles for a second time interval, wherein a start of the second time interval corresponds to a time at which the change in the load of the vehicle occurred, calculate a load pitch angle based on the second averaged pitch angle, and adjust a position of a stepper motor based on the load pitch angle.

An example non-transitory machine readable storage medium includes instructions to cause programmable circuitry to at least determine a first averaged pitch angle corresponding to a first set of pitch angles determined for a first time interval, determine whether a change in a load of a vehicle has occurred during the first time interval based on at least one parameter indicating a change in the load of the vehicle, determine, in response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred, and adjust a position of a headlamp based on the second averaged pitch angle.

### BRIEF DESCRIPTION OF THE DRAWINGS

FIG. 1 shows a schematic diagram of a variant of a method according to examples disclosed herein for determining the current load pitch angle of a vehicle in the form of a flowchart.

FIG. 2 shows a schematic diagram of buffering of average values formed that can be implemented in examples disclosed herein.

FIG. 3 shows a schematic drawing of a method in accordance with teachings of this disclosure for beam height adjustment in the form of a flowchart.

FIG. 4 shows a schematic diagram of a motor vehicle according to examples disclosed herein with a device for beam height adjustment.

FIG. 5 is a block diagram of an example processing platform including programmable circuitry structured to execute, instantiate, and/or perform the example machine-readable instructions and/or perform the example operations of FIG. 3 to implement electronic steering systems and/or components thereof disclosed herein.

In general, the same reference numbers will be used throughout the drawing(s) and accompanying written description to refer to the same or like parts. The figures are not necessarily to scale.

### DETAILED DESCRIPTION

Automatic headlamp beam height adjustment systems can necessitate a current load pitch angle of a vehicle with respect to a road surface as an essential input variable. A change in the pitch angle can occur in particular due to a driving style or as a result of loading or unloading of the vehicle (e.g., a car with a loaded trunk). When the load pitch angle changes, the headlamps must be readjusted (e.g., corrected upwards or downwards with respect to their beam angle). For motor vehicles registered in the European Union (EU), automatic beam height adjustment systems are mandatory for certain types of headlamps.

A pitch angle of a vehicle can be determined using two mechanical height sensors, wherein a first height sensor is mounted on the front axle and a second height sensor is mounted on the rear axle. The height sensors provide information about a change in the suspension height, in which case an electrical output signal from the height sensor changes to influence a headlamp angle of the vehicle.

As used herein, an averaged pitch angle refers to the measuring angle of a system that determines an averaged pitch angle when the vehicle is driving (e.g., a camera that determines a horizon angle via a series of images). The load pitch angle is the quasi-static component of the pitch angle, which depends only on the loading, but not on the driving situation. It corresponds to the angle that is set when the vehicle is at a standstill on a horizontal surface. The dynamic pitch angle refers to the current (e.g., the instantaneous, rapidly varying, etc.) deviation of the pitch angle from the load pitch angle, in other words the portion of the pitch angle that depends on the driving situation (e.g., braking, accelerating, uphill, downhill).

To determine the dynamic pitch angle, the longitudinal acceleration of the vehicle can be measured, which usually correlates with the dynamic pitch angle because the dynamic pitch angle is mainly caused by acceleration forces that act on a predominantly linearly spring-mounted system.

Typically, the pitch angle of a vehicle is determined by utilizing two mechanical level sensors, with a first level sensor being mounted on the front axle and a second level sensor mounted on the rear axle. The level sensors provide information about a change in the suspension height, wherein an electrical output signal from the level sensor changes depending on the suspension height of the vehicle. This signal can be used by a control unit (e.g., a headlamp control module (HCM)) to calculate the pitch angle and to control a stepper motor within the headlamp for its adjustment. In combination with knowledge of the wheelbase, a direct, accurate and rapid method for determining the change in the pitch angle of a vehicle, for example, due to additional loading or other factors, is thus available. There are also other variants available that are based on only one level sensor, typically on the rear axle.

However, these sensors are relatively complex to integrate into existing vehicles. They are also maintenance-intensive, as they are directly exposed to environmental effects such as the weather, and mechanical effects caused by the road surface, in particular possible stone chips. It is therefore desirable to replace the previously described solution based on mechanical sensors with suitable alternatives. A combination of other existing sensors proves particularly useful. While it is possible to determine the load pitch angle using other sensors, typically ones already present in a vehicle, such as acceleration sensors, it can be difficult to achieve the required accuracy, however, which allows only small tolerances for lighting requirements.

Known methods can determine an average pitch angle with respect to the road surface based on images acquired by a front-facing camera. The averaged pitch angle is typically determined while the vehicle is driving. Because the vehicle pitch angle can vary depending on driving conditions, such that the vehicle pitch angle may change in connection with an ascent or descent for example, the average pitch angle determined by the camera also differs from the pitch angle of the vehicle that occurs when the vehicle comes to a standstill in a horizontal plane (“load pitch angle”). However, a headlamp beam height adjustment system necessitates this load pitch angle as an input variable.

Known documents DE 10 2017 005 019 A1, DE 10 2020 128 440 A1, DE 10 2011 017 697 A1, US 2021/0323466 A1 and US 2017/0225609 A1 describe methods and devices for adjusting the headlamp beam height using a camera. In document U.S. Pat. No. 10,953,787 B2, various sensors are used in connection with headlamp beam height adjustment. Further known documents include EP 2 130 718 A2, CN 112477750 B, DE 10 2021 006290 A1, EP 0 709 240 A1, U.S. Pat. Nos. 6,693,380 B2, 6,450,673 B1, 6,193,398 B1, 9,260,051 B2 and US 2016/0288698 A1.

Against this background, examples disclosed herein provide advantageous methods for determining the current load pitch angle of a vehicle for automatic headlamp beam height adjustment. Examples disclosed herein provide advantageous methods for headlamp beam height adjustment, advantageous devices for headlamp beam height adjustment, vehicles, computer-implemented methods, computer program products, and a computer-readable carrier media having instructions to be executed by processors.

Examples described herein provide methods for determining the current load pitch angle of a vehicle, methods for headlamp beam height adjustment, devices for headlamp beam height, vehicles, computer-implemented methods, computer program products, and a computer-readable media having instructions to be executed by processors..

The examples methods disclosed herein for determining (e.g., estimating) the current load pitch angle of a vehicle for automatic beam height adjustment of at least one headlamp (e.g., a front headlamp) of the vehicle relates to a vehicle which includes at least one device for determining, for example, measuring or calculating, an averaged pitch angle. The vehicle also includes at least a device for acquiring at least one parameter which indicates a change or a possible change in the loading of the vehicle.

A device for determining an averaged pitch angle may include an environment detection device, such as a camera, for example. The environment detection device may be utilized and/or configured for detecting the road ahead of the vehicle. Advantageously, the environment detection device can determine the current horizon line for determining an averaged pitch angle of the vehicle, that is, for determining the deviation of the pitch angle from the factory state or from the unloaded state.

The method according to examples disclosed herein includes the following operations. Within a fixed or defined time interval or time window, in particular one which can be defined by the camera or the respective measuring system, data is collected for determining an averaged pitch angle of the vehicle. The time window is usually not fixed in advance, but can be based on the driving situation. It may not be possible to collect usable data in every driving situation. The time interval or time window can be a calibration time interval or calibration time window, for example. Utilizing a plurality of data points recorded within the time interval or time window, the averaged pitch angle is determined (e.g., estimated or calculated). In a further operation, the average is formed from a number (e.g., a fixed number, preferably a plurality) of consecutively determined averaged pitch angles.

At least one parameter indicating a change or possible change in the loading of the vehicle, is acquired (e.g., detected). This also occurs preferably as a function of time (e.g., during the fixed or defined time interval or time window). Based on the at least one parameter detected, which indicates a change or possible change in the loading state of the vehicle, it is determined whether a change in the loading of the vehicle has taken place or could have taken place, in particular when a change in the loading of the vehicle took place or could have taken place. If it is determined that a change in the vehicle loading has occurred or could have occurred before the start of the time interval or time window, the averaging is reset and restarted. After the restart, the average value is formed, that is, the average value is formed over a fixed number, preferably a plurality, of consecutively determined averaged pitch angles starting with the averaged pitch angle from the time window or time interval before the start of which a change in the loading of the vehicle took place or could have taken place. The current load pitch angle is then determined on the basis of the last average formed over the number (e.g., a fixed number, preferably a plurality) of consecutively determined averaged pitch angles.

The entire method can be repeated continuously (e.g., repeated periodically or multiple times).

The method according to examples disclosed herein has the advantage that a change or possible change in the loading of the vehicle is considered very quickly and efficiently in the context of the calculation of the current load pitch angle.

Advantageously, the average is formed from at least 3, preferably at least 5, consecutively determined averaged pitch angles. On the one hand, this achieves improved accuracy, in particular reduced noise, of the calculated averaged pitch angle and thus also of the resulting current load pitch angle, and on the other hand, a reliable result for the current load pitch angle is delivered within a short time. In principle, the number of values of the averaged pitch angles used for the averaging determines the accuracy of the result. To obtain a quick result, the number or window or interval of values that are averaged over should not be too large.

In an advantageous example, after resetting and restarting the averaging, the averaging takes place from an increasing number of consecutively determined averaged pitch angles up to a specified maximum number. This ensures that updated and reliable values for the current load pitch angle can be generated very quickly.

If it is determined in the context of the method that no change in the vehicle loading has occurred before the start of the time interval, the averaging of the specified number of consecutively determined averaged pitch angles can be continued. The current load pitch angle is, thus, determined based on the last averaged value from the number (e.g., a fixed number, preferably a plurality of consecutively determined averaged pitch angles).

A parameter indicating a change or possible change in the loading state of the vehicle can include a variety of parameters. For example, it is possible to detect a change in a gravitational angle (e.g., with reference to a defined reference axis of the vehicle) and/or a change in a operating state, in particular the opening and/or closing state of a window, a door and/or a tailgate of the vehicle. Further, some examples may include detecting a change in a operating state of at least one seat belt, preferably a plurality or all seat belts of the vehicle, a change in a operating state of a trailer coupling, and/or a change in the operating state of a parking brake. Additionally, it is possible to record the vehicle cabin (e.g. passenger compartment) and/or luggage compartment using a device (e.g., a camera to identify a change or possible change in the load) to indicate a change in load of the vehicle.

Thus, two procedures or methods are combined with each other within the context of examples disclosed herein for determining the current load pitch angle. On the one hand, the current load pitch angle is determined based on an average of mean pitch angles (e.g., using a camera system). The camera system can calculate a mean pitch angle based on data acquired in a specific calibration time window. Furthermore, changes in the vehicle loading are tracked and considered (e.g., immediately taken into account). For example, changes in the gravitational angle can be observed during loading or unloading of the vehicle and/or a change in the loading state of the vehicle can be derived from other measured values or parameters. While a camera system can be utilized for determining the load pitch angle requires movement of the vehicle, a system for observing and tracking the gravitational angle, or for observing and tracking other parameters indicating a change in the loading state of the vehicle, can be utilized even when the vehicle is at a standstill.

The method according to examples disclosed herein has the advantage that a load pitch angle can be determined without the use of the level sensors described above. Thus, in connection with a headlamp beam height adjustment, the utilization of level sensors may be omitted in the future. In addition, the reliability of the determination of the load pitch angle and, thus, the headlamp beam height adjustment is improved, because no moving components are required for determining the pitch angle. The reliability and accuracy of the determination of the load pitch angle is also improved due to a change in the loading of the vehicle being precisely considered in the determination with little or no time delay. In this way, distorted results resulting from an unexpected change in the vehicle loading are avoided.

An example device for determining (e.g., measuring and/or calculating) an averaged pitch angle of the vehicle may comprise at least one camera.

An example method disclosed herein for adjusting the beam height of at least one headlamp, for example a front headlamp, of a vehicle includes the following operations. First, a setting position of the at least one headlamp is determined. The prerequisite for this is an adjustment of the zero angle. Thus, with a nominal basic setting of a stepper motor angle, the headlamp is calibrated as part of the assembly in such a way that a defined light exit gradient is achieved. Normally, the headlamp is set (by activation) to a “zero position” at the end of the production line. Because the headlamps as a component are subject to large mechanical tolerances, the angle is then corrected by adjusting screws (or electronic activation) so that the light is emitted at a fixed angle. This process is also known as “adjustment” or “aiming” and provides the setting position as a prerequisite for any further compensation. Subsequent beam height adjustment or “leveling” identifies changes in the angle between the vehicle and the ground and compensates for the fixed light exit angle or the required deviation from the setting position.

Subsequent to the determination of the setting position of the at least one headlamp, the current load pitch angle of the vehicle is determined by a method according to examples disclosed herein that are described above. In a subsequent or next operation, the deviation of the current load pitch angle of the vehicle from the setting position and thus the resulting deviation of the at least one headlamp from the setting position is determined. In particular, a new setpoint angle can be defined. The setting, in particular the light output angle, of the at least one headlamp is then adjusted according to the determined deviation. In particular, the new, defined setpoint angle can be activated. The beam height can be adjusted by mechanically rotating a pivot frame by the required angle (e.g., controlled) by a stepper motor. With high-resolution pixel headlights, it is also possible to switch pixel rows on or off so that little or no light is emitted above the desired light-dark limit. In other words, a change in the light output angle can be compensated.

The method according to examples disclosed herein for beam height adjustment has the features and advantages described above in connection with the method according to examples for determining the current pitch angle of the vehicle.

A device according to examples disclosed herein for adjusting the headlight beam height of at least one headlamp of a vehicle relates to a vehicle which comprises at least a device for determining an averaged pitch angle, in particular an environment detection device, for example a camera (e.g., a front-mounted camera) and a device for acquiring/detecting at least one parameter characterizing a change or possible change in the loading of the vehicle. The device for determining an averaged pitch angle may be implemented to detect the road ahead of the vehicle and/or to determine an averaged pitch angle of the vehicle.

The device according to examples disclosed herein for beam height adjustment can receive data from a device for determining an averaged pitch angle (e.g., the environment detection device) and from the device for acquiring or detecting at least one parameter characterizing a change in the loading of the vehicle, and to carry out a method according to examples disclosed herein described above for adjusting the headlamp beam height. The device according to examples disclosed herein for beam height adjustment has the features and advantages already mentioned in connection with the method according to examples disclosed herein.

In some examples, acquiring (e.g., detecting) at least one parameter characterizing a change or possible change in the loading of the vehicle includes utilizing at least one gravitation sensor and/or at least one device (e.g., a camera) for recording the cabin and/or the luggage compartment and/or at least one sensor for detecting the operating state of at least one seat belt and/or at least one sensor for detecting the operating state (e.g., the opening and/or closing state) of the windows and/or doors and/or a tailgate of the vehicle, and/or at least one sensor for detecting the operating state of a parking brake of the vehicle and/or at least one sensor for detecting the operating state of a trailer coupling of the vehicle. Other example devices for recording the cabin are an ultrasonic sensor in the interior, which detects the presence of cargo and/or persons, or an interior microphone or seat mats with load detection, which are also used for restraint systems and seat belt monitoring, for example.

The vehicle according to examples disclosed herein comprises a device for beam height adjustment described above. The vehicle has the advantages already described. The vehicle can be an electric vehicle or a hybrid electric vehicle (HEV). The vehicle can be a motor vehicle (e.g., a passenger car, a truck, a bus, a minibus, a motorcycle or a moped. etc.).

The computer-implemented method according to examples disclosed herein includes commands, which during the execution of the program by a computer cause said computer to carry out a method according to examples disclosed herein. The computer program product according to examples disclosed herein includes commands, which during the execution of the program by a computer, cause said computer to carry out a method according to examples disclosed herein described above. The computer program product according to examples disclosed herein is stored on the computer-readable data carrier according to examples disclosed herein. The data carrier signal according to examples disclosed herein transmits the computer program product according to examples disclosed herein. The computer-implemented method according to examples disclosed herein, the computer program product according to examples disclosed herein, the computer-readable data carrier according to examples disclosed herein, and the data carrier signal according to examples disclosed herein have the above-mentioned features and advantages.

The figures are not necessarily accurate in every detail or true to scale and can be shown enlarged or reduced to provide a better overview. Therefore, functional details disclosed herein are not to be understood in a restrictive sense, but merely as a descriptive basis which offers guidance to the person skilled in the art in this field of technology for applying examples disclosed herein in a variety of ways.

As used herein, the term “and/or”, when used in a series of two or more elements, means that each of the items listed can either be used alone, or else any combination of two or more of the listed elements can be used. For example, if a combination is described which contains the components A, B and/or C, the combination can contain A alone; B alone; C alone; A and B in combination; A and C in combination; B and C in combination; or A, B, and C in combination.

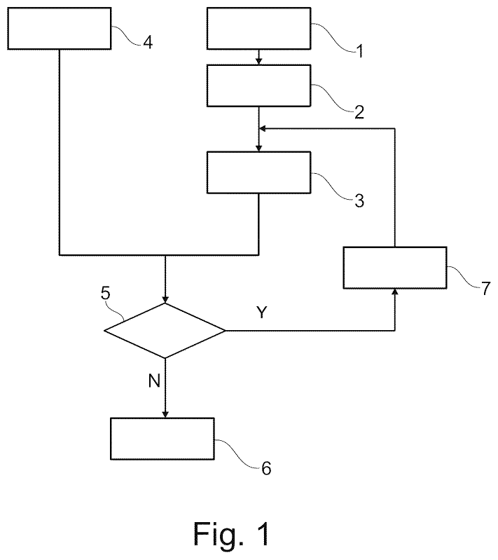

FIG. 1 shows a schematic diagram of a variant of a method according to examples disclosed herein for determining the current load pitch angle of a vehicle in the form of a flowchart. In operation 1, data is collected within a fixed or specified time interval or time window to determine an averaged pitch angle of the vehicle. In operation 2, the averaged pitch angle is determined (e.g., estimated or calculated) based on a plurality of data points recorded within the time interval or time window. In a further operation 3, the average value is formed from a number (e.g., a fixed number, preferably a plurality) of consecutively determined averaged pitch angles. For example, the average value can be determined from any 5 consecutively determined averaged pitch angles.

In operation 4, which may be carried out, for example, simultaneously as operation 1, at least one parameter characterizing a change or possible change in the loading of the vehicle is acquired, for example detected. This also occurs preferably as a function of time (e.g., during the fixed or defined time interval or time window in which the data is recorded in operation 1). Based on the at least one detected parameter, which indicates a change or possible change in the loading state of the vehicle, in operation 5 it is determined whether a change in the loading of the vehicle has taken place or could have taken place, in particular whether a change in the loading of the vehicle took place or could have taken place during the specified time interval or time window.

If in operation 5 it is determined that no change has taken place before the start of the time interval or time window, in operation 6 the current load pitch angle is determined based on the last average value formed over the number (e.g., a fixed number, preferably plurality), such as 5 consecutively determined averaged pitch angles, for example.

If it is determined in operation 5 that a change in the vehicle loading has occurred or could have occurred before the start of the time interval or time window, the averaging from operation 3 is reset and restarted in operation 7. After the restart, the average value is formed, that is, the averaging is performed over a fixed number, preferably a plurality, of consecutively determined averaged pitch angles starting with the averaged pitch angle from the time window or time interval before the start of which a change in the loading of the vehicle took place or could have taken place. In this way, in the event of a change in the vehicle loading, the values of the averaged pitch angles used for the averaging are selectively buffered.

Then the method is continued with operations 3 and 5 as described above. The example method can be repeated continuously or at specific time intervals.

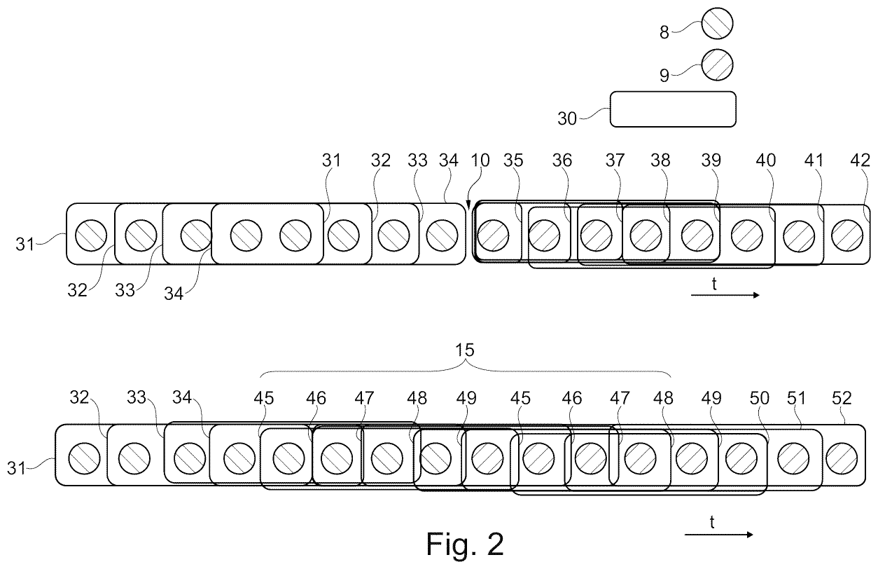

FIG. 2 schematically illustrates the buffering according to examples disclosed herein (FIG. 2 top) of the averaged values in comparison to an averaging without buffering according to examples disclosed herein (FIG. 2, lower diagram). The points marked with the reference signs 8 and 9 indicate individual averaged pitch angles determined consecutively in the direction of a time axis t. In such examples, the points 8 indicate averaged pitch angles in a first loading state of the vehicle and the points 9 indicate averaged pitch angles in a second loading state of the vehicle that differs from the first loading state.

The average value is formed in the example shown in FIG. 2 over a maximum of 5 consecutively determined averaged pitch angles 8 and/or 9. The values 8 and 9 of the averaged pitch angles used for a single averaging operation are combined by frames or buffer windows 30.

First, the method of averaging without buffering according to examples disclosed herein will be explained using the lower diagram in FIG. 2. First, the average value is formed from the first 5 values enclosed by the frame 31 for consecutively determined averaged pitch angles 8. Then, the average value is formed from the second 5 values enclosed by the frame 32 for consecutively determined averaged pitch angles 8. This is continued according to the frames or windows for the averaging 33, 34 and 45 through 52.

The bracket 15 designates the region in which averaged pitch angles 8 and 9 (i.e., averaged pitch angles for different loading states of the vehicle) are used together in an averaging operation. This specifically applies to the mean values from averaged pitch angles 8 and 9 which are grouped together in the windows or frames 45 to 48. The current load pitch angles calculated based on these average values only form an inaccurate figure for the load pitch angle. Only starting from the average of the values 9 combined in frame 49 is the current load pitch angle based thereon reliable, because this does not include any averaged pitch angles from the first loading state, which no longer corresponds to the current loading state of the vehicle.

The resulting time delay until the change in the loading state can be reliably considered as undesirable and is reduced or avoided according to examples disclosed herein as shown in FIG. 2, top diagram. The first four average values 31 to 34 are formed as previously shown in connection with the example shown in FIG. 2, lower diagram. At the time indicated by the arrow 10, a change or possible change in the loading state of the vehicle is recorded or detected. This time occurs prior to the start of the time interval in which the data points for determining the previous first averaged pitch angle 9 in the second loading state are recorded.

The further averaging from the calculated averaged pitch angles 8 or 9 is now reset and restarted. In window or frame 35, therefore, only the first averaged pitch angle 9 is utilized to determine the current load pitch angle. Subsequent to determining the second averaged pitch angle 9, in this example, only the first two averaged pitch angles 9 are used in window or frame 36 to determine the current load pitch angle. In the following averaging operations according to frames 37 to 39, first three, then four and finally five averaged pitch angles 9 are used to determine the current load pitch angle. Thereafter, in the averaging operations according to frames 40 to 42, the average is again formed over five consecutively determined averaged pitch angles 9. The described example method has the advantage that reliable values for the current load pitch angle can be determined immediately after a change in the loading state of the vehicle. Accordingly, the time delay described above can be avoided.

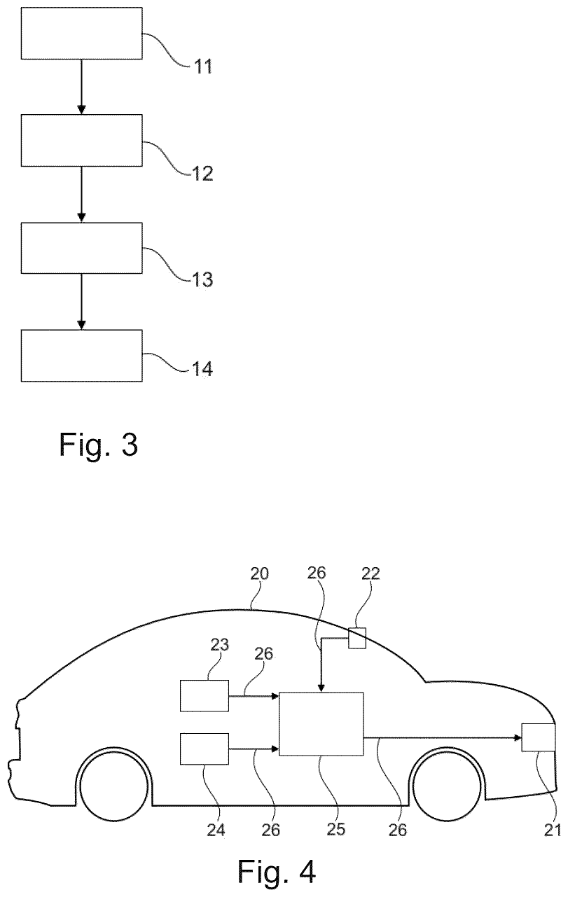

FIG. 3 shows a schematic drawing of a method according to examples disclosed herein for beam height adjustment illustrated as a flowchart. In operation 11, a setting position of the at least one headlamp for controlling the beam height is determined. The prerequisite for this is an adjustment of the zero angle. Thus, with a nominal basic setting of a stepper motor angle, the headlamp is calibrated as part of the assembly in such a way that a defined light exit gradient is achieved. This can mean that the headlamp is mechanically and/or optically calibrated (headlamp adjustment). In doing so, a zero angle command can be issued to set the beam height, which this also then moves to. At the same time, the corresponding load pitch angle (e.g., reference load angle, zero load angle) can be determined (e.g., in a reference station with known targets).

In operation 12, the current load pitch angle of the vehicle is determined, in particular relative to the zero load angle or to the setting position determined in operation 11, for example via a method explained with reference to FIGS. 1 and 2. In operation 13, based on the determined current load pitch angle of the vehicle, the deviation of the current load pitch angle from the setting position is determined and, thus, the resulting deviation of the headlamp from the setting position. In this context, a new setpoint angle can be defined. Then, in operation 14, the setting, in particular the light exit angle of the at least one headlamp, is adjusted according to the determined deviation (e.g., the defined, new target angle is activated).

Example instructions and/or operations of FIGS. 1 and 3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 shows a schematic drawing of a motor vehicle 20 according to examples disclosed herein having a device 25 for beam height adjustment in accordance with teachings of this disclosure. The vehicle 20 comprises at least one headlamp 21, for example a front headlamp, and a device 22 for determining (e.g., a means for determining) an averaged pitch angle of the vehicle, in particular an environment detection device 22, for example implemented as a camera, which may be mounted in particular on a windscreen. Furthermore, the vehicle 20 or the device for beam height adjustment 25 comprises a device 23 for detecting (e.g., a means for detecting) at least one parameter characterizing a change or possible change in the loading of the vehicle 20. In some examples, the vehicle 20 or the device for beam height adjustment 25 may include at least one gravitation sensor 24 (e.g., for detecting a change or possible change in the loading state of the vehicle or for reference measurements).

The device for beam height adjustment 25 is implemented to receive data from the device for determining an averaged pitch angle of the vehicle 22 and from the device 23 for detecting at least one parameter characterizing a change or a potential change in the loading of the vehicle 20, and to carry out a method according to examples disclosed herein for beam height adjustment, for example, a method described with reference to FIGS. 1 and 2. The data transmission is indicated in FIG. 4 by arrows with the reference sign 26. For setting, in particular for controlling or adjusting the beam height of the headlamp 21, the beam height adjustment device 25 transmits corresponding data to a control unit, for example for controlling a stepper motor within the headlamp 21.

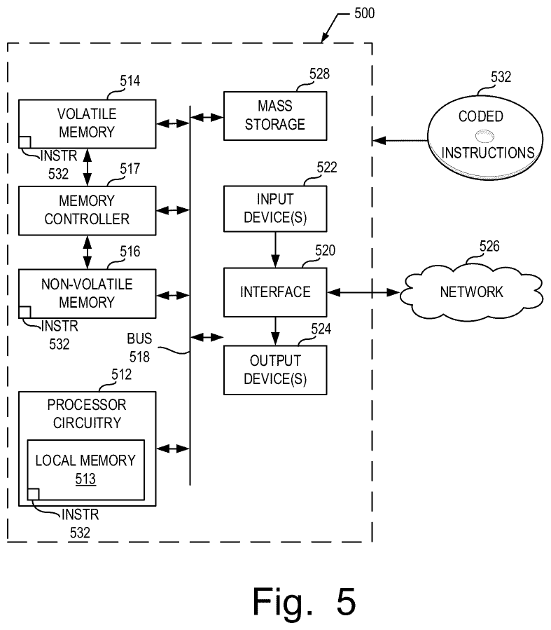

FIG. 5 is a block diagram of an example programmable circuitry platform 500 structured to execute and/or instantiate the example machine-readable instructions and/or the example operations of FIG. 3 to implement examples disclosed herein. The programmable circuitry platform 500 can be, for example, a control device, an electronic control unit (ECU), a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 532, which may be implemented by the machine-readable instructions of FIG. 3, may be stored in the mass storage device 528, in the volatile memory 514, in the non-volatile memory 516, and/or on at least one non-transitory computer readable storage medium such as a CD or DVD which may be removable.

Example methods, apparatus, systems, and articles of manufacture to enable effective control of a headlamp based on current load pitch angle are disclosed herein. Further examples and combinations thereof include the following:

Example 1 includes a method for determining a load pitch angle of a vehicle, the method including determining a first averaged pitch angle corresponding to a first set of pitch angles determined for a first time interval, determining whether a change in a load of the vehicle has occurred during the first time interval based on at least one parameter indicating a change in the load of the vehicle, determining, in response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred, calculating the load pitch angle based on the second averaged pitch angle, and adjusting a position of a headlamp of the vehicle based on the load pitch angle.

Example 2 includes the method of example 1, including resetting the load pitch angle at or before the start of the second time interval.

Example 3 includes the method of example 1, including truncating the second set of pitch angles based on the time at which the change in the load of the vehicle occurred.

Example 4 includes the method of example 1, including if it is determined that the change in the load of the vehicle has not occurred during the first time interval, calculating the load pitch angle based on the first averaged pitch angle.

Example 5 includes the method of example 1, wherein the at least one parameter indicating a change in the load of the vehicle includes at least one of a change in a gravitational angle of the vehicle, a change in an operating state of a window, a door, and/or a tailgate of the vehicle, a change in an operating state of a seat belt of the vehicle, a change in an operating state of a trailer coupling of the vehicle, or a change in an operating state of a parking brake, a cabin and/or a luggage compartment of the vehicle.

Example 6 includes the method of example 1, wherein the first averaged pitch angle and the second averaged pitch angle are determined based on output from a camera.

Example 7 includes the method of example 1, wherein adjusting a position of the headlamp of the vehicle includes adjusting a position of a stepper motor coupled to the headlamp.

Example 8 includes a device for automatic beam adjustment of at least one headlamp of a vehicle including a first sensor to collect first data including a plurality of pitch angles, a second sensor to collect second data including at least one parameter indicating a change in a load of the vehicle, machine readable instructions, and programmable circuitry to execute the machine-readable instructions to determine a first averaged pitch angle corresponding to a first set of pitch angles determined for a first time interval based on the first data, determine whether a change in the load of the vehicle has occurred based on the second data, determine, in response to the change of the load of the vehicle occurring during the first time interval, a second averaged pitch angle corresponding to a second set of pitch angles for a second time interval, wherein a start of the second time interval corresponds to a time at which the change in the load of the vehicle occurred, calculate a load pitch angle based on the second averaged pitch angle, and adjust a position of the at least one headlight based on the load pitch angle.

Example 9 includes the device of example 8, wherein the second sensor includes a gravitation sensor.

Example 10 includes the device of example 8, wherein the first time interval and the second time interval overlap.

Example 11 includes the device of example 8, wherein the second sensor includes an image sensor for a cabin or a luggage compartment of the vehicle.

Example 12 includes the device of example 8, wherein the second sensor includes an ultrasonic sensor to detect a presence of cargo and/or persons in the vehicle.

Example 13 includes the device of example 8, wherein the second sensor detects an operating state of at least one seat belt of the vehicle.

Example 14 includes the device of example 8, wherein the first sensor includes a camera.

Example 15 includes the device of example 8, wherein the first data includes a current horizon line of the vehicle.

Example 16 includes a non-transitory machine readable storage medium including instructions to cause programmable circuitry to at least determine a first averaged pitch angle corresponding to a first set of pitch angles determined for a first time interval, determine whether a change in a load of a vehicle has occurred during the first time interval based on at least one parameter indicating a change in the load of the vehicle, determine, in response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred, and cause adjustment of a position of a headlamp based on the second averaged pitch angle.

Example 17 includes the non-transitory machine readable storage medium of example 16, wherein the instructions cause the programmable circuitry to restart and reset averaging of pitch angles from the time at which the change in the load of the vehicle occurred.

Example 18 includes the non-transitory machine readable storage medium of example 16, wherein the first time interval and the second time interval overlap.

Example 19 includes the non-transitory machine readable storage medium of example 16, including if it is determined that the change in the load of the vehicle has not occurred during the first time interval, calculating the second averaged pitch angle based on the first set of pitch angles.

Example 20 includes the non-transitory machine readable storage medium of example 16, wherein the first averaged pitch angle and the second averaged pitch angle are determined based on output from a camera.

What is claimed is:

1. A method for determining a load pitch angle of a vehicle, the method comprising:
determining a first averaged pitch angle corresponding to a first set of pitch angles determined for a first time interval;
determining whether a change in a load of the vehicle has occurred during the first time interval based on at least one parameter indicating a change in the load of the vehicle;
determining, in a response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred;
calculating the load pitch angle based on the second averaged pitch angle; and
adjusting a position of a headlamp of the vehicle based on the load pitch angle.

2. The method according to claim 1, including resetting the load pitch angle at or before the start of the second time interval.

3. The method according to claim 1, including truncating the second set of pitch angles based on the time at which the change in the load of the vehicle occurred.

4. The method according to claim 1, including if it is determined that the change in the load of the vehicle has not occurred during the first time interval, calculating the load pitch angle based on the first averaged pitch angle.

5. The method according to claim 1, wherein the at least one parameter indicating a change in the load of the vehicle includes at least one of:
a change in a gravitational angle of the vehicle;
a change in an operating state of a window, a door, and/or a tailgate of the vehicle;
a change in an operating state of a seat belt of the vehicle;
a change in an operating state of a trailer coupling of the vehicle; or
a change in an operating state of a parking brake, a cabin and/or a luggage compartment of the vehicle.

6. The method according to claim 1, wherein the first averaged pitch angle and the second averaged pitch angle are determined based on output from a camera.

7. The method according to claim 1, wherein adjusting a position of the headlamp of the vehicle includes adjusting a position of a stepper motor coupled to the headlamp.

8. A device for automatic beam adjustment of at least one headlamp of a vehicle comprising:
a first sensor to collect first data including a plurality of pitch angles;
a second sensor to collect second data including at least one parameter indicating a change in a load of the vehicle;
machine-readable instructions; and
programmable circuitry to execute the machine-readable instructions to:
determine a first averaged pitch angle corresponding to a first set of pitch angles determined for a first time interval based on the first data;
determine whether a change in the load of the vehicle has occurred based on the second data;
determine, in response to the change of the load of the vehicle occurring during the first time interval, a second averaged pitch angle corresponding to a second set of pitch angles for a second time interval, wherein a start of the second time interval corresponds to a time at which the change in the load of the vehicle occurred;
calculate a load pitch angle based on the second averaged pitch angle; and
adjust a position of the at least one headlight based on the load pitch angle.

9. The device according to claim 8, wherein the second sensor includes a gravitation sensor.

10. The device according to claim 8, wherein the first time interval and the second time interval overlap.

11. The device according to claim 8, wherein the second sensor includes an image sensor for a cabin or a luggage compartment of the vehicle.

12. The device according to claim 8, wherein the second sensor includes an ultrasonic sensor to detect a presence of cargo and/or persons in the vehicle.

13. The device according to claim 8, wherein the second sensor detects an operating state of at least one seat belt of the vehicle.

14. The device according to claim 8, wherein the first sensor includes a camera.

15. The device according to claim 8, wherein the first data includes a current horizon line of the vehicle.

16. A non-transitory machine readable storage medium comprising instructions to cause programmable circuitry to at least:
determine a first averaged pitch angle corresponding to a first set of pitch angles determined for a first time interval;
determine whether a change in a load of a vehicle has occurred during the first time interval based on at least one parameter indicating a change in the load of the vehicle;
determine, in response to the change of the load of the vehicle occurring during the first time interval, a second averaged pitch angle corresponding to a second set of pitch angles determined for a second time interval, wherein a start of the second time interval corresponds to a time at which the change in the load of the vehicle occurred; and
cause adjustment of a position of a headlamp based on the second averaged pitch angle.

17. The non-transitory machine readable storage medium of claim 16, wherein the instructions cause the programmable circuitry to restart and reset averaging of pitch angles from the time at which the change in the load of the vehicle occurred.

18. The non-transitory machine readable storage medium of claim 16, wherein the first time interval and the second time interval overlap.

19. The non-transitory machine readable storage medium of claim 16, including if it is determined that the change in the load of the vehicle has not occurred during the first time interval, calculating the second averaged pitch angle based on the first set of pitch angles.

20. The non-transitory machine readable storage medium of claim 16, wherein the first averaged pitch angle and the second averaged pitch angle are determined based on output from a camera.
